(19) United States
(12) Patent Application Publication
(10) Pub. No.: US 2020/0133060 A1
(43) Pub. Date: Apr. 30, 2020

(54) THIN CIRCULAR POLARIZER FOR DISPLAY APPLICATIONS

(71) Applicant: Sharp Kabushiki Kaisha, Osaka (JP)

(72) Inventors: Nathan James Smith, Oxford (GB); Andrew Acreman, Oxford (GB)

(21) Appl. No.: 16/174,667

(22) Filed: Oct. 30, 2018

(51) Int. Cl. G02F 1/1335; G02B 27/28; G02B 5/30; G02F 1/13363

(52) U.S. Cl. CPC G02F 1/133528; G02B 27/281; G02F 2001/133638; G02F 1/13363; G02F 2001/133541; G02B 5/3016

(57) ABSTRACT

A flexible circular polarizer includes from a viewing side: a substrate; a liquid crystal (LC) polarizer layer; and a quarter wave plate reactive mesogen (RM) retarder layer. An optical axis of the RM retarder is aligned in a first direction and a transmission axis of the LC polarizer is aligned in a second direction different from the first direction, and an angle between the first and second directions has a value of 45°±15°. At least one of the substrate and the LC polarizer has a surface configuration that imparts an alignment to an adjacent non-viewing side layer. The LC polarizer layer may have a surface configuration that imparts an alignment to the RM retarder in the first direction, and/or the substrate may have a surface configuration that imparts an alignment to the LC polarizer in the second direction. A flexible display system includes from a viewing side the flexible circular polarizer, and a display device that is adhered to the flexible circular polarizer. The flexible display system is repeatedly reconfigurable between a planar state and a non-planar state, such as being bent, folded, rolled, flexed, and/or curved from the planar state.

### TECHNICAL FIELD

The present invention relates to thin circular polarizers and methods of making thin circular polarizers, wherein embodiments of said thin circular polarizers are used to reduce reflections from an electronic image display device particularly in applications pertaining to flexible or bendable display devices.

### BACKGROUND ART

Reducing reflections of ambient lighting from a display improves the contrast ratio of the display, and therefore enables better image quality. Electronic displays, and in particular organic light-emitting diode (OLED) displays, may be operated with a single circular polarizer adhered to the viewing side of the display device to reduce reflections. An example of such usage of a circular polarizer is described in U.S. Pat. No. 6,549,335 (Trapani et al., issued Apr. 15, 2003).

In the field of circular polarizers, U.S. Pat. No. 9,766,384 (Kamada et al., issued Sep. 19, 2017) describes the use of a circular polarizer that includes a liquid crystal (LC) retarder with a hybrid aligned nematic configuration in combination with a linear polarizer to reduce reflections from a display device. U.S. Pat. No. 9,159,958 (Jeon et al., issued Oct. 13, 2015) describes the use of a circular polarizer that includes a reactive mesogen (RM) quarter wave plate retarder, a non-retardation triacetate cellulose protective layer, a linear polarizer, and a further protective layer to reduce reflections from a display device, wherein the RM quarter wave plate retarder is coated directly on top of an OLED display. U.S. Pat. No. 7,638,796 (Kwak et al., issued Dec. 29, 2009) describes the use of a circular polarizer that includes a phase difference film, a wire grid polarizer, and a dye-based polarizer to reduce reflections from a display device. US 2017007517 (Lee et al., published Mar. 16, 2017) describes the use of a circular polarizer that includes a polarizer, a photoalignment layer, and a liquid crystal layer wherein the polarizer includes a polyolefin and dichroic dye. U.S. Pat. No. 7,169,447 (Su Yu et al., issued Jan. 30, 2007) describes the use of a circular polarizer that includes a quarter wave plate retarder, a half wave plate retarder, and a linear polarizer to reduce reflections from a display device.

As generally illustrative of such devices, FIG. 1 is a drawing depicting an exemplary display system 10, which includes a display device 12 on which there is disposed a circular polarizer 14 on the display device. The circular polarizer 14 may be adhered to the display device 12 using an optical adhesive 16. The circular polarizer in particular is disposed on a viewing side 18 of the display device 12. As referenced above, the circular polarizer functions to reduce reflections of ambient lighting (such as sunshine, room light, and other external light) from the display device 12. The layered configuration of FIG. 1 is commonly referred to as an optical stack. A coordinate system (x, y, z) in FIG. 1 illustrates that the viewing direction is in the z direction, and the plane of the display device 12 is in the x-y plane. Unless stated otherwise, the coordinate system (x, y, z) shown in FIG. 1 is applicable to all subsequent figures that depict an optical stack configuration.

FIG. 2A is a drawing depicting an example configuration of a conventional circular polarizer 14a. A conventional circular polarizer 14a generally includes a linear polarizer 20 and a retarder layer 22 configured in an optical stack. The linear polarizer 20 typically is made of polyvinyl alcohol (PVA), and the retarder 22 typically is made of a stretched polymer material, such as polycarbonate, polyvinyl alcohol or cyclo-olefin polymer. The retarder 22 functions as a quarter wave plate (QWP) retarder with an optical axis orientated at approximately 45° relative to the transmission axis of the linear polarizer 20. An optical adhesive layer (not shown) typically is used to bond the linear polarizer 20 and the retarder 22. As known to those of ordinary skill in the art, the linear polarizer 20 typically includes several different layers, and the details of these specific layers are omitted for simplicity. The overall thickness of the circular polarizer 14a and the adhesive layer 16 (see FIG. 1) is typically about 130-170 μm.

Recently, flexible or bendable display systems have been developed, which have several advantages over rigid display systems. For example, flexible or bendable display systems may be bent, curved, rolled, and/or folded for compact storage, for protection of the viewing side components, to provide unique types of image presentation, and the like. A conventional circular polarizer with a thickness 130-170 μm, however, is not particularly suitable for a display system that is designed to be flexible or bendable because the circular polarizer thickness is too thick in the viewing z direction to be non-rigid. Essentially, a circular polarizer of such thickness adds significant stiffness to the overall display system to preclude a flexible or bendable display system.

Thinner circular polarizers, therefore, have been developed to be suitable for flexible or bendable display applications. For example, FIG. 2B is a drawing depicting an alternative configuration of a circular polarizer that may be used in flexible or bendable display applications. As illustrated, a circular polarizer 14b is configured as an optical stack that may include from the viewing side 18 a substrate 24, an LC polarizer alignment layer 26, an LC polarizer 28, a reactive mesogen (RM) alignment layer 30, and an RM retarder 32. The thickness of the circular polarizer 14b including the adhesive layer 16 (see FIG. 1) is typically about 90-130 μm. Although a circular polarizer with a thickness of about 90-130 μm may be suitable for a display system that is designed to be flexible or bendable, it is desirable to reduce the thickness of the circular polarizer still further for enhanced flexibility. Hong Jiang Ni et al discuss various polymers that may be suitable flexible substrates for optoelectrical devices, such as flexible active matrix organic light emitting display devices (“A review on colorless and optically transparent polyimide films: Chemistry, process and engineering applications”, DOI 10.1016/j.jiec.2015.03.013). In general, thinner circular polarizers have lower stiffness which enables the display system to be folded, bended, flexed, rolled and/or curved more easily. A further advantage of a thin circular polarizer is reduced weight, which is particularly advantageous for mobile products. Decreasing the thickness of the circular polarizer remains a significant challenge in the art.

### SUMMARY OF INVENTION

The present invention pertains to circular polarizer configurations and related methods of forming a circular polarizer that decrease the thickness of the circular polarizer relative to conventional configurations. A circular polarizer adhered to the viewing side (i.e. the front) of an electronic display device reduces reflections of ambient lighting (such as sunshine, room lighting or other external lighting) from the display device. Reducing ambient reflections from a display device is beneficial because contrast ratio is improved and thus enables better image quality. In addition, with the configurations and methods of this disclosure, the thickness of the circular polarizer is decreased relative to conventional configurations so as to be more suitable for use in flexible or bendable display systems.

The disclosed configurations and manufacturing methods yield thin circular polarizers with a thickness of less than 70 μm (excluding adhesive layer 16 of FIG. 1) that is more suitable for a flexible or bendable display system. Such circular polarizers can be bent, folded, flexed, rolled, and/or curved such that said thin circular polarizers and related display systems are able to maintain a minimum radius of curvature of less than 10 mm. In addition, such circular polarizers and related display systems can be repeatedly bent, folded, flexed, rolled, and/or curved from a straightened or planar state, and otherwise are mechanically less stiff as compared to conventional circular polarizers. To achieve the decreased thickness, the circular polarizers of the present disclosure are configured with fewer composite layers enabling lower production costs, while still performing effective reduction of ambient light reflections.

An aspect of the invention, therefore, is a flexible circular polarizer that is more suitable for flexible and bendable display systems as compared to conventional configurations. In exemplary embodiments, a flexible circular polarizer includes from a viewing side: a substrate; a liquid crystal (LC) polarizer layer; and a quarter wave plate reactive mesogen (RM) retarder layer. An optical axis of the RM retarder is aligned in a first direction and a transmission axis of the LC polarizer is aligned in a second direction different from the first direction, and an angle between the first and second directions has a value of 45°±15°. At least one of the substrate and the LC polarizer has a surface configuration that imparts an alignment to an adjacent non-viewing side layer.

For example, the LC polarizer layer may have a surface configuration that imparts an alignment to the RM retarder in the first direction, and/or the substrate may have a surface configuration that imparts an alignment to the LC polarizer in the second direction. During manufacture, the layer with the surface configuration that imparts alignment to a non-viewing side layer may be subjected to an aligning process prior to depositing the adjacent non-viewing side layer. For example, an aligning process may be performed on the LC polarizer prior to depositing the RM retarder, and the aligning process forms a surface configuration on the LC polarizer that imparts an alignment to the RM retarder in the first direction; and/or an aligning process is performed on the substrate prior to depositing the LC polarizer, and the aligning process forms a surface configuration on the substrate that imparts an alignment to the LC polarizer in the second direction. The aligning process may be a rubbing process and/or an ultraviolet radiation exposure process. The flexible circular polarizer is repeatedly reconfigurable between a planar state and a non-planar state, such as being bent, folded, rolled, flexed, and/or curved from the planar state.

Accordingly, another aspect of the invention is a flexible display system that includes from a viewing side the flexible circular polarizer according to any of the embodiments, and a display device that is adhered to the flexible circular polarizer. The flexible display system in turn is repeatedly reconfigurable between a planar state and a non-planar state, such as being bent, folded, rolled, flexed, and/or curved from the planar state.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a schematic drawing depicting a conventional display system.

FIG. 2A is a schematic drawing depicting a conventional circular polarizer.

FIG. 2B is a schematic drawing depicting another conventional circular polarizer that is intended for use in a flexible display system.

FIG. 3 is a schematic drawing depicting an exemplary circular polarizer in accordance with embodiments of the present invention, in which an LC polarizer acts as a dual function layer.

FIG. 4 is a schematic drawing depicting an exemplary circular polarizer that is a variation of the embodiment of FIG. 3, in which an additional hard coat layer is provided on the viewing side of the optical stack.

FIG. 5 is a schematic drawing depicting an exemplary circular polarizer in accordance with embodiments of the present invention, in which a substrate layer acts as a dual function layer.

FIG. 6 is a schematic drawing depicting an exemplary circular polarizer that is a variation of the embodiment of FIG. 5, in which an additional hard coat layer is provided on the viewing side of the optical stack.

FIG. 7 is a schematic drawing depicting an exemplary circular polarizer in accordance with embodiments of the present invention, in which both an LC polarizer and a substrate layer act as a dual function layers.

FIG. 8 is a schematic drawing depicting an exemplary circular polarizer that is a variation of the embodiment of FIG. 7, in which an additional hard coat layer is provided on the viewing side of the optical stack.

FIG. 9 is a schematic drawing depicting an exemplary circular polarizer in accordance with embodiments of the present invention, in which an LC polarizer and substrate functionality are combined into a dual function layer.

FIG. 10 is a schematic drawing depicting an exemplary circular polarizer that is a variation of the embodiment of FIG. 9, in which an additional hard coat layer is provided on the viewing side of the optical stack.

FIG. 11 is a schematic drawing depicting another exemplary circular polarizer in accordance with embodiments of the present invention, in which an LC polarizer and substrate functionality are combined into a dual function layer.

FIG. 12 is a schematic drawing depicting an exemplary circular polarizer that is a variation of the embodiment of FIG. 11, in which an additional hard coat layer is provided on the viewing side of the optical stack.

FIG. 13 is a drawing depicting an exemplary display system in accordance with embodiments of the present invention, in which a circular polarizer according to any of the embodiments is combined with a display device.

FIG. 14 is a schematic drawing depicting an exemplary display system that is a variation of the embodiment of FIG. 13, in which an additional antireflection layer is provided on the viewing side of the optical stack.

FIG. 15A is a schematic drawing depicting an exemplary display system in accordance with embodiments of the present invention, in a first or planar state.

FIG. 15B is a schematic drawing depicting the exemplary display system of FIG. 15A in a second or non-planar state, in which the non-planar state is a folded state.

FIG. 16A is a schematic drawing depicting an exemplary display system in accordance with embodiments of the present invention, in a first or planar state.

FIG. 16B is a schematic drawing depicting the exemplary display system of FIG. 16A in a second or non-planar or state in which the non-planar state is a rolled state.

### DESCRIPTION OF EMBODIMENTS

The present invention pertains to circular polarizer configurations and related methods of forming a circular polarizer that decrease the thickness of the circular polarizer relative to conventional configurations. A circular polarizer adhered to the viewing side (i.e. the front) of an electronic display device reduces reflections of ambient lighting (such as sunshine, room lighting, or other external lighting) from the display device. Reducing ambient reflections from a display device is beneficial because contrast ratio is improved and thus enables better image quality. In addition, with the configurations of methods of this disclosure, the thickness of the circular polarizer is decreased relative to conventional configurations so as to be more suitable for use in flexible or bendable display systems.

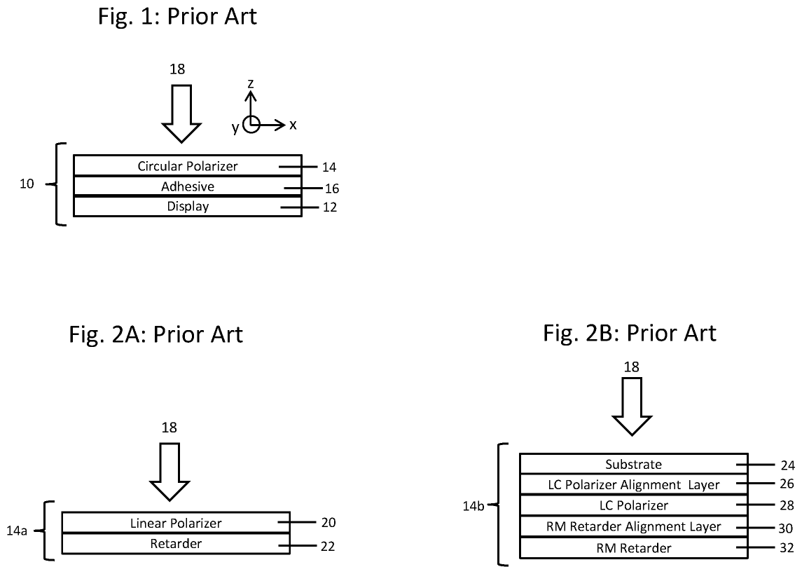

The notion of a flexible or bendable display system has not been specifically or universally defined in the art. As used herein, terms such as “bendable display”, “foldable display”, “flexible display”, “curved display” and the like refer to display devices that generally are configured to be modified intentionally and repeatedly between a first state that is a conventional planar state and a second state that is a non-planar state for ordinary usage, storage, transport, or the like. Examples of non-planar states include flexed, folded, rolled, bent, and curved states and the like. The disclosed configurations and manufacturing methods yield thin circular polarizers with a thickness of less than 70 μm (excluding adhesive layer 16 of FIG. 1) that is more suitable for such a flexible or bendable display system. Such circular polarizers can be bent, folded, rolled, flexed and/or curved such that said thin circular polarizers and related display systems are able to maintain a region having a minimum radius of curvature of less than 10 mm. In addition, such circular polarizers and related display systems can be repeatedly bent, folded, rolled, flexed and/or curved between the planar state and the non-planar state, and otherwise are mechanically less stiff as compared to conventional circular polarizers. To achieve the decreased thickness, the circular polarizers of the present disclosure are configured with fewer composite layers enabling lower production costs, while still performing effective reduction of ambient light reflections.

The formation of the described circular polarizers generally is achieved via application of optical layers to a substrate. Such optical layers may include, for example, various combinations of an LC polarizer alignment layer, an LC polarizer with an RM retarder alignment layer function, an LC polarizer without an RM retarder alignment layer function, an RM retarder alignment layer, an RM retarder layer, and a hard coat. The deposition of any given layer may be performed using any suitable deposition process. Examples include a slot die coating process, a spray coating process, a spin coating process, a roll coating process, a printing process, an evaporation process, or a drop casting process. Various configurations employing different layer structures of such or a subset of such components are described in connection with the subsequent figures. The substrate may be a thin (e.g., <50 μm) polymer substrate, a polymer substrate with an LC polarizer alignment layer function, a polymer substrate with a polarizer function, or a polymer substrate with both a polarizer function and an RM retarder alignment layer function. Generally, as used herein, the term LC (liquid crystal) encompasses liquid crystal materials that may be a reactive mesogen (RM) LC layer, a lyotropic LC layer, a nematic LC layer, and/or a smectic LC layer.

The described configurations of a circular polarizer generally employ a linear polarizer and an RM retarder, wherein a transmission axis of the linear polarizer differs from an alignment direction of the RM retarder layer, such as by approximately 45°. In addition, the transmission axis of the linear polarizer is independent of a surface property of a layer that aligns the RM retarder. In this manner, a single layer, for example the linear polarizer or substrate or other base layer, may perform a dual function including appropriate orienting or transmission of light combined with alignment of an adjacent layer. With such dual functionality of certain layers in the various circular polarizer configurations, additional layers that are present in conventional configurations may be eliminated, thereby resulting in an overall thinner configuration that is more suitable for flexible display applications.

An aspect of the invention, therefore, is a flexible circular polarizer that is more suitable for flexible and bendable display systems as compared to conventional configurations. In exemplary embodiments, a flexible circular polarizer includes from a viewing side: a substrate; a liquid crystal (LC) polarizer layer; and a quarter wave plate reactive mesogen (RM) retarder layer. An optical axis of the RM retarder is aligned in a first direction and a transmission axis of the LC polarizer is aligned in a second direction different from the first direction, and an angle between the first and second directions has a value of 45°±15°. At least one of the substrate and the LC polarizer has a surface configuration that imparts an alignment to an adjacent non-viewing side layer.

For example, the LC polarizer layer may have a surface configuration that imparts an alignment to the RM retarder in the first direction, and/or the substrate may have a surface configuration that imparts an alignment to the LC polarizer in the second direction. During manufacture, the layer with the surface configuration that imparts alignment to a non-viewing side layer may be subjected to an aligning process prior depositing the adjacent non-viewing side layer. For example, an aligning process may be performed on the LC polarizer prior to depositing the RM retarder, and the aligning process forms a surface configuration on the LC polarizer that imparts an alignment to the RM retarder in the first direction; and/or an aligning process is performed on the substrate prior to depositing the LC polarizer, and the aligning process forms a surface configuration on the substrate that imparts an alignment to the LC polarizer in the second direction. The aligning process may be a rubbing process and/or an ultraviolet radiation exposure process. The flexible circular polarizer is repeatedly reconfigurable between a planar state and a non-planar state, such as being bent, folded, rolled, flexed, and/or curved from the planar state.

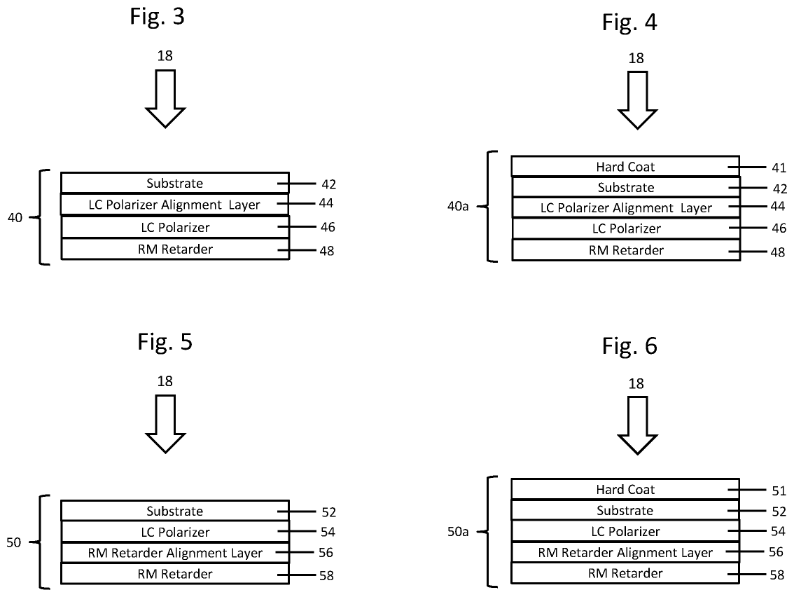

In accordance with such features, FIG. 3 is a schematic drawing depicting an exemplary circular polarizer 40 in accordance with embodiments of the present invention in which an LC polarizer acts as a dual function layer. The circular polarizer 40 includes from the viewing side 18 a substrate 42, an LC polarizer alignment layer 44, an LC polarizer 46, and an RM retarder 48. The substrate 42 is an optically transparent and colorless polymer film with a thickness, t, that may be in the range 3 μm<t<50 μm, and preferably in the range 7 μm<t<35 μm. The substrate 42 may contain at least one of the following materials: polyethylene terephthalate (PET), Poly(methyl methacrylate) (i.e. PMMA), Polyethylene naphthalate (PEN), cyclo olefin polymer (COP), cyclo olefin copolymer (COC), polycarbonate (PC), high temperature polycarbonate (HTPC), polyetherimide (PEI), polyarcylate (PAR), polyphenylene sulfide (PPS), polyethersulfone (PES), polyether ether ketone (PEEK), polyimide (PI) or polyamide imide (PAI). Colorless and transparent polyimide (CPI) films and their analogues, including PAI and PEI, may be particularly well suited as the substrate for the circular polarizer 40 because of the following attributes: high optical transparency, colorless or very pale color, high thermal stability, and excellent mechanical properties. High thermal stability is particularly important as many manufacturing processes employ a baking process for depositing one or more of the additional layers into the optical stack, and those baking processes may employ relatively high temperatures such as up to 280° C. The principal function of substrate 42 is to be the base layer upon which all other layers pertaining to the circular polarizer are subsequently deposited. Again, in this and other subsequent embodiments, the substrate layer is on the viewing side 18 of the optical stack.

The LC polarizer alignment layer 44 is coated onto the substrate 42 and may be a conventional LC alignment layer, such as for example polyimide (PI). After the LC polarizer alignment layer 44 is deposited onto the substrate 42, the LC polarizer alignment layer 44 may be subjected to a baking process (up to 280° C.). After the baking process, the exposed surface of the LC polarizer alignment layer 44 may be subjected to an aligning process. In general, the purpose of an aligning process in this context is to create a template on the surface of a given layer so that said layer can impart an alignment direction to other materials (such as LCs and RMs) that are subsequently deposited on said layer. The aligning process of the LC polarizer alignment layer 44 may be a rubbing process and/or a UV (ultraviolet) radiation exposure process as are known in the art. As examples, when a UV radiation exposure process is used as the aligning process for the LC polarizer alignment layer 44, the UV radiation may have a wavelength of approximately 254 nm for a bond breaking process, and/or the UV radiation may have a wavelength of approximately around 365 nm for a bond making process, depending upon the nature of the desired resultant alignment effect and the material comprising the LC polarizer alignment layer 44. The UV radiation also may be linearly polarized. The LC polarizer alignment layer 44 aligning process is performed before deposition of the LC polarizer 46, so that the LC polarizer alignment layer 44 has a surface configuration that can then impart an alignment to align the transmission axis of the LC polarizer 46 in a direction that is in the x-y plane.

As is typical for a circular polarizer, the LC polarizer 46 is a linear polarizer, and the LC polarizer 46 is deposited on the LC polarizer alignment layer 44. As referenced above, the LC polarizer alignment layer 44 has a surface configuration that aligns the transmission axis of the LC polarizer 46 in the x-y plane. The LC polarizer 46 may be a guest-host type LC polarizer, i.e. a dye doped LC polarizer, whereby a dye or a mixture of dyes and an LC material are mixed and deposited on the LC polarizer alignment layer 44. The LC material of the LC polarizer 46 may be an RM material, or may be a mixture of an LC material and polymer-precursors that can be subsequently polymerized to form a solid film. As another example, the LC polarizer 46 may be a lyotropic LC dye or a mixture of lyotropic LC dyes, or a mixture of lyotropic LC and a dye or a mixture of dyes. The lyotropic LC, the dye, or both may be polymerized to a solid film. In the case of a lyotropic LC, the polymerization may occur before, during or after evaporation of the lyotropic LC solvent. The LC polarizer 46 alternatively may be polymerized via a UV radiation exposure and/or a heating process.

After the LC polarizer 46 has been deposited on the LC polarizer alignment layer 44 and polymerized (if applicable), a non-viewing side surface of the LC polarizer 46 is then subjected to an aligning process. The purpose of the aligning process in this context is to create a template on the exposed (non-viewing side) surface of the LC polarizer 46 so that the LC polarizer 46 has a surface configuration that can impart a predefined alignment direction to another material layer that is subsequently deposited onto the LC polarizer 46, such as for example another LC layer or an RM layer. An aligning process is not performed on the LC polarizer in conventional circular polariser configurations.

Without such additional aligning process, then another material layer (such as LC and RM) that is subsequently deposited, in general, will tend to align either parallel to perpendicular to the transmission axis of the LC polarizer 46. In contrast, the aligning process of the LC polarizer 46 enables the LC polarizer 46 to have a transmission axis in a second direction, while the surface configuration of the LC polarizer 46 imparts an alignment in a first direction to LC materials (including RMs and lyotropic LCs) that are subsequently deposited on the LC polarizer 46. The first and second directions are in the x-y plane, and the second direction is different from the first direction by a predetermined amount suitable for a particular application, and such difference is determined by the aligning process applied to the LC polarizer 46.

The aligning process of the LC polarizer 46 may be a rubbing process and/or a UV (ultra-violet) radiation exposure process as described above. Again, in an example when a UV radiation exposure process is used as the aligning process for the LC polarizer 46, the UV radiation may have a wavelength of approximately 254 nm for a bond breaking process, and/or a wavelength of approximately 365 nm for a bond making process depending upon the desired alignment result and the material comprising the LC polariser 46. The UV radiation also may be linearly polarized, and a wavelength of approximately 254 nm for a bond breaking process has been determined to be particularly suitable for achieving the circular polarizer device shown in FIG. 3. The angle between the linearly polarized UV radiation and the first direction are related and dependent upon the type of material subsequently deposited onto the surface of the LC polarizer 46. The angle between the linearly polarized UV radiation and the first direction may be 0° (i.e. parallel) or 90° (i.e. perpendicular).

Referring to the specific configuration of FIG. 3, an RM retarder 48 is deposited on the LC polarizer 46 to complete the circular polarizer 40. The aligning process applied to the non-viewing side surface of the LC polarizer 46 results in said surface configuration of the LC polarizer 46 aligning the optical axis of the RM retarder 48 in the first direction, whereas the transmission axis of the LC polarizer is in the second direction. Accordingly, the LC polarizer 46 aligning process is performed before deposition of the RM retarder 48. Consequently, the LC polarizer has been processed to simultaneously perform two distinct functions in the circular polarizer 40, which differs from conventional configurations. The first function of the LC polarizer 46 is a linear polarizer function to transmit linearly polarized light in the second direction as done in conventional configurations. The second function of the LC polarizer 46 is an alignment layer function by which the LC polarizer aligns the RM retarder 48 in the first direction, which is not performed by the LC polarizer in conventional configurations. Rather, conventionally an additional alignment layer is deposited and processed on the LC polarizer 46 to align the RM retarder 48. By performing the aligning process on the LC polarizer 46 such that the polarizer performs an additional alignment layer function, the additional RM alignment layer 30 that is present in the conventional configuration of FIG. 2B is omitted from the optical stack of the present invention as depicted in FIG. 3. The circular polarizer 40, therefore, has fewer optical layers than a conventional circular polarizer, which has advantages of lower manufacturing costs and reduced thickness. With the reduced thickness, the circular polarizer 40 is more suitable for use in flexible or bendable display devices.

As referenced above, the first direction (RM alignment direction) and second direction (polarizer transmission axis) are both in the x-y plane. In exemplary embodiments, the angle, φ, between the first direction and the second direction is 45°±15° and preferably 45°, i.e. the angle, φ, between the optical axis of the RM retarder 46 and the transmission axis of the LC polarizer 46 is 45°±15° and preferably 45°. The RM retarder 48 is a quarter wave plate (QWP) that can convert linearly polarized light to circularly polarized light and vice versa. The RM retarder 48 may have a positive dispersion curve, a flat dispersion curve, or a negative dispersion curve. An RM retarder 48 with a negative dispersion curve has an advantage that the RM retarder 48 is able to convert a wider range of optical wavelengths into circularly polarized light than an RM retarder with either a flat dispersion curve or positive dispersion curve. An RM retarder 48 with a negative dispersion curve, in combination with the LC polarizer 46, is therefore able to reduce reflections from the display device more effectively, which enables better image quality in ambient lighting. On a comparable basis, an RM retarder 48 with a flat dispersion curve is advantageous over an RM retarder with a positive dispersion curve.

FIG. 4 is a schematic drawing depicting an exemplary circular polarizer 40a that is a variation of the embodiment of FIG. 3, in which an additional hard coat layer 41 is provided on the viewing side of the optical stack. The hard coat layer 41 protects the other layers, and in particular the substrate 42, from scratches. The hard coat layer 41 may have a surface structure that further functions as an antireflection surface, and the antireflection surface structure may be embossed into the hard coat layer 41 on the viewing side 18. The hard coat layer 41 may be an LC material, or may be an epoxy material. The hard coat layer 41 further may be a quarter wave plate retarder with an optical axis at approximately 45° relative to the transmission axis of the LC polarizer 46.

FIG. 5 is a schematic drawing depicting another exemplary circular polarizer 50 in accordance with embodiments of the present invention, in which the substrate acts as the dual function layer. In this embodiment, the circular polarizer 50 includes from the viewing side 18 a substrate 52, an LC polarizer 54, an RM alignment layer 56 and an RM retarder 58. The substrate 52 is an optically transparent and colorless polymer film, and generally may have a thickness and composition comparably as the substrate 42 of the previous embodiment.

As referenced above, in this embodiment the substrate 52 operates as the dual function layer. The first function of the substrate 52 is a substrate function to act as the base layer on which subsequent layers are deposited. In addition, as the second function the substrate 52 aligns the LC polarizer 54 in the second direction. The substrate 52 may be manufactured in such a way, for example, using a stretching process to have a surface configuration that has an intrinsic alignment function that aligns the LC polarizer 52. Alternatively, an aligning process such as described above may be applied to the non-viewing side surface of the substrate 52 form a surface configuration that is able to align the LC polarizer 54 in the second direction. The aligning process applied to substrate 52 may be a rubbing process and/or a UV (ultraviolet) radiation exposure process similarly as the aligning process performed on the LC polarizer 46 of the previous embodiment. Accordingly, in an example when a UV radiation exposure process is used as the aligning process for the substrate 52, the UV radiation may have a wavelength of approximately 254 nm (a bond breaking process) and/or a wavelength of approximately 365 nm (a bond making process), and the UV radiation may be linearly polarized. The substrate 52 aligning process is performed before deposition of the LC polarizer 54 and functions to form a surface configuration to align the optical axis of the LC polarizer 54 in the second direction. By configuring the surface configuration of substrate 52 to perform the alignment of the LC polarizer 54, the LC polarizer alignment layer 26 of the conventional configuration of FIG. 2B is omitted. The circular polarizer 50, therefore, also includes fewer optical layers than a conventional circular polarizer, and thus also has advantages of lower manufacturing costs and reduced thickness to be more suitable for flexible or bendable displays.

As in the previous embodiment, the LC polarizer 54 is a linear polarizer that has a transmission axis in the second direction, which is in the x-y plane. The LC polarizer 54 may have a material composition comparably as the LC polarizer of the previous embodiment. In the embodiment of FIG. 5, however, the LC polarizer 54 does not perform the second function of linear polarizer 46 to impart an alignment to the RM retarder. Rather, in the embodiment of FIG. 5, a separate RM retarder alignment layer 56 is coated onto the LC polarizer 54 and may be a conventional LC alignment layer, such as a PI layer. After the RM retarder alignment layer 56 is deposited onto the LC polarizer 54, the RM retarder alignment layer 40 may be subjected to a high temperature baking process (e.g., up to about 280° C.). After the baking process, the exposed surface of RM retarder alignment layer 56 may be subjected to an aligning process to create a template that can impart an alignment direction to the RM retarder 58 in the first direction. The aligning process may be a rubbing process and/or a UV (ultraviolet) radiation exposure process comparably as described above in connection with aligning processes applied to other layers.

Again, the first direction corresponding to the RM retarder alignment (RM retarder optical axis) and the second direction corresponding to the LC polarizer alignment (polarizer transmission axis) are both in the x-y plane and are different from each other. Comparably as above, the angle, φ, between the first direction and the second direction is 45°±15° and preferably 45°.

FIG. 6 is a schematic drawing depicting an exemplary circular polarizer 50a that is a variation of the embodiment of FIG. 5, in which an additional protective hard coat layer 51 is provided on the viewing side of the optical stack. The hard coat layer 51 may be configured and function comparably as the hard coat layer of the previous embodiment, including having an antireflection surface and/or being configured as a quarter wave plate retarder with an optical axis at approximately 45° relative to the transmission axis of the LC polarizer 54.

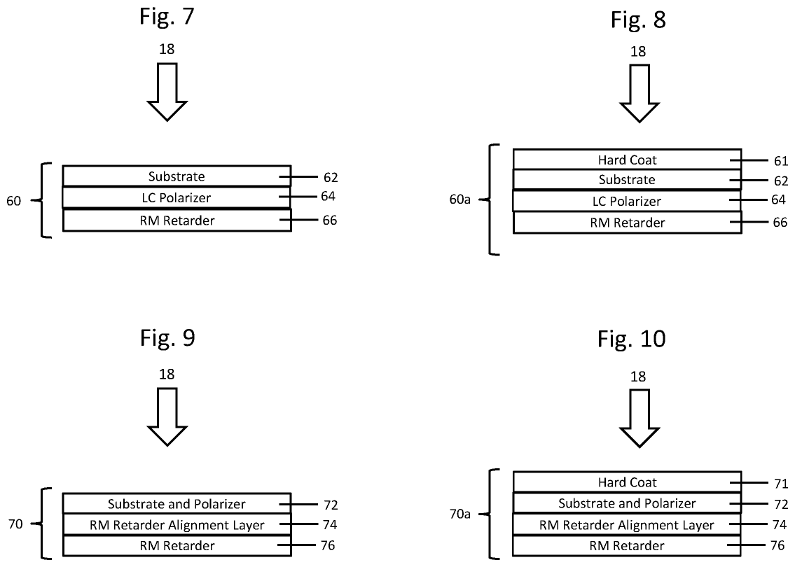

FIG. 7 is a schematic drawing depicting an exemplary circular polarizer 60 in accordance with embodiments of the present invention, in which both the LC polarizer and the substrate act as dual function layers. The circular polarizer 60 includes from the viewing side 18 a substrate 62, an LC polarizer 64, and an RM retarder 66. This embodiment essentially combines features of the embodiments of FIGS. 3 and 5, in that both the substrate 62 and LC polarizer 64 operate as dual function layers in which one of such functions is to impart an alignment on an adjacent non-viewing side layer. The aligning processes that may be applied to the substrate 62 and LC polarizer 64 to achieve the alignment functionality may be comparable as described above.

Accordingly, the first function of substrate 62 is to act as a base layer upon which the other layers are subsequently deposited, as is conventional. The second function of substrate 62 is to impart an alignment to the LC polarizer 64 in the second direction, which is not performed in conventional configurations. In this manner, the separate LC polarizer alignment layer 26 of the conventional configuration of FIG. 2B is omitted. Similarly, the first function of the LC polarizer 64 is to act as a linear polarizer that transmits light linearly polarized in the second direction, as is conventional. The second function of the LC polarizer 64 is to impart an alignment to the RM Retarder 66, which is not performed in conventional configurations. In this manner, the RM retarder alignment layer 30 of the conventional configuration of FIG. 2B also is omitted. The circular polarizer 60, therefore, also includes fewer optical layers than a conventional circular polarizer, and thus also has advantages of lower manufacturing costs and reduced thickness to be more suitable for flexible or bendable displays.

Similarly as in previous embodiments, the first direction corresponding to the RM retarder alignment (RM retarder optical axis) and the second direction corresponding to the LC polarizer alignment (polarizer transmission axis) are both in the x-y plane and are different from each other. Comparably as above, the angle, φ, between the first direction and the second direction is 45°±15° and preferably 45°.

FIG. 8 is a schematic drawing depicting an exemplary circular polarizer 60a that is a variation of the embodiment of FIG. 7, in which an additional protective hard coat layer 61 is provided on the viewing side of the optical stack. The hard coat layer 61 may be configured and function comparably as the hard coat layer of the previous embodiments, including having an antireflection surface and/or being configured as a quarter wave plate retarder with an optical axis at approximately 45° relative to the transmission axis of the LC polarizer 64.

FIG. 9 is a schematic drawing depicting an exemplary circular polarizer 70 in accordance with embodiments of the present invention, in which the LC polarizer and the substrate functionality are combined into a dual function layer. The circular polarizer 70 includes from the viewing side 18 a combined substrate/polarizer 72, an RM retarder alignment layer 74, and an RM retarder 76. The combined substrate/polarizer 72 is an optically transparent and colorless polymer film, and generally may have a thickness and composition comparably as in the substrates of the previous embodiments. To incorporate light polarizing capabilities into the combined substrate/polarizer 72, such layer further may include an aligned dye or mixture of aligned dyes, and/or aligned metal particles such as silver. The metal particles may be rod shaped, and the alignment of any dye(s) and/or metal particles may be achieved via a stretching process applied to the combined substrate/polarizer 72 during manufacture. The aligned dye(s) or metal particles within the combined substrate/polarizer 72 result in such structure being configured to function as a linear polarizer with a transmission axis in the second direction.

Accordingly, the first function of the combined substrate/polarizer 72 is to act as a base layer upon which the other layers are subsequently deposited, as is conventional. The second function of the combined substrate/polarizer 72 is to act as a linear polarizer that transits light that is linearly polarized in the second direction. The combination of a substrate function and a linear polarizer function into a single layer differs from the conventional configurations. In this manner, the separate LC polarizer 28 and the additional LC polarizer alignment layer 26 of the conventional configuration of FIG. 2B are omitted. The circular polarizer 70, therefore, also includes fewer optical layers than a conventional circular polarizer, and thus also has advantages of lower manufacturing costs and reduced thickness to be more suitable for flexible or bendable displays.

In the embodiment of FIG. 9, an RM retarder alignment layer 74 is deposited on the combined substrate/polarizer 72, which is structured and formed comparably as RM retarder alignment layers of previous embodiments. An RM retarder layer 76 is deposited on the RM retarder alignment layer 74, which is structured and formed comparably as RM retarder layers of previous embodiments.

Also similarly as in previous embodiments, the first direction corresponding to the RM retarder alignment (RM retarder optical axis) and the second direction corresponding to the combined substrate/polarizer 72 transmission axis are both in the x-y plane and are different from each other. Comparably as above, the angle, φ, between the first direction and the second direction is 45°±15° and preferably 45°.

FIG. 10 is a schematic drawing depicting an exemplary circular polarizer 70a that is variation of the embodiment of FIG. 9, in which an additional protective hard coat layer 71 is provided on the viewing side of the optical stack. The hard coat layer 71 may be configured and function comparably as the hard coat layer of the previous embodiments, including having an antireflection surface and/or being configured as a quarter wave plate retarder with an optical axis at approximately 45° to the transmission axis of the combined substrate/polarizer 72.

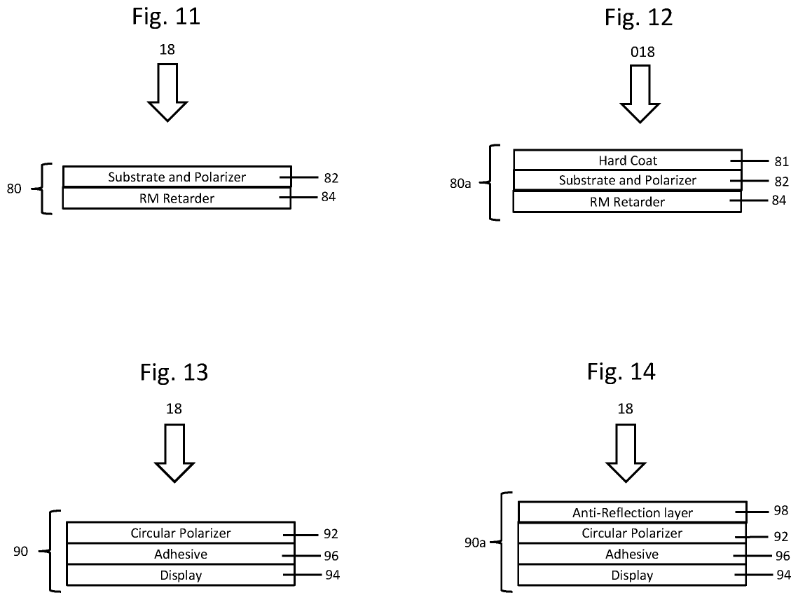

FIG. 11 is a schematic drawing depicting an exemplary circular polarizer 80 in accordance with embodiments of the present invention, in which the LC polarizer and the substrate functionality are combined into a dual function layer and such structure can further impart an alignment to an RM retarder. The circular polarizer 80 includes from the viewing side 18 a combined substrate/polarizer 82, and an RM retarder 84. The combined substrate/polarizer 82 is an optically transparent and colorless polymer film, and generally may have a thickness and composition comparably as in the substrates of the previous embodiments. In addition, similarly as in the embodiment of FIG. 9, to incorporate light polarizing capabilities into the combined substrate/polarizer 82, such layer further may include an aligned dye or mixture of aligned dyes, and/or aligned metal particles such as silver. The metal particles may be rod shaped, and the alignment of any dye(s) and/or metal particles may be achieved via a stretching process applied to the combined substrate/polarizer 82 during manufacture. The aligned dye(s) or metal particles within the combined substrate/polarizer 82 result in such structure being configured to function as a linear polarizer with a transmission axis in the second direction.

In the embodiment of FIG. 11, the combined substrate/polarizer 82 further is configured to impart an alignment to RM retarder 84 in the first direction. To configure the combined substrate/polarizer 82 to perform such alignment function, the combined substrate/polarizer 82 may be manufactured in such a way, for example, using a stretching process to form a surface configuration that has an intrinsic alignment function that aligns the RM retarder 84. Alternatively, an aligning process may be applied to the non-viewing side surface of the combined substrate/polarizer 82 to form a surface configuration that is able to align the RM retarder 84 in the first direction. Similarly as aligning processes described with respect to previous embodiments, an aligning process applied to the combined substrate/polarizer 82 may be a rubbing process and/or a UV (ultraviolet) radiation exposure process. The combined substrate/polarizer 82 aligning process is performed before deposition of the RM retarder 84 and functions to align the optical axis of the RM retarder 84 in the first direction.

Accordingly, the combined substrate/polarizer 82 of this embodiment is processed to be configured to perform three functions. The first function of the combined substrate/polarizer 82 is to act as a base layer upon which the RM retarder layer is subsequently deposited, as is conventional. The second function of the combined substrate/polarizer 82 is to act as a linear polarizer that transits light that is linearly polarized in the second direction. The third function of the combined substrate/polarizer 82 is to impart an alignment direction to set the optical axis of the RM retarder 84. The combination of a substrate function, a linear polarizer function, and an RM retarder alignment function into a single layer differs from the conventional configurations. In this manner, the separate LC polarizer 28, the additional LC polarizer alignment layer 26, and the additional RM retarder alignment layer 30 of the conventional configuration of FIG. 2B are omitted. The circular polarizer 80, therefore, also includes fewer optical layers than a conventional circular polarizer, and thus also has advantages of lower manufacturing costs and reduced thickness to be more suitable for flexible or bendable displays.

Also similarly as in previous embodiments, the first direction corresponding to the RM retarder alignment (RM retarder optical axis) and the second direction corresponding to the combined substrate/polarizer 82 transmission axis are both in the x-y plane and are different from each other. Comparably as above, the angle, φ, between the first direction and the second direction is 45°±15° and preferably 45°.

FIG. 12 is a schematic drawing depicting an exemplary circular polarizer 80a that is a variation of the embodiment of FIG. 11, in which an additional protective hard coat layer 81 is provided on the viewing side of the optical stack. The hard coat layer 81 may be configured and function comparably as the hard coat layer of the previous embodiments, including having an antireflection surface and/or being configured as a quarter wave plate retarder with an optical axis at approximately 45° relative to the transmission axis of the combined substrate/polarizer 82.

With respect to the various embodiments described above, an overall thickness in the viewing z direction of the circular polarizers is less than 70 μm. Such a thickness renders a circular polarizer according to any of the embodiments particularly suitable for use in flexible or bendable display devices. Accordingly, another aspect of the invention is a flexible display system that includes from a viewing side the flexible circular polarizer according to any of the embodiments, and a display device that is adhered to the flexible circular polarizer. The flexible display system in turn is repeatedly reconfigurable between a planar state and a non-planar state, such as being bent, folded, rolled, flexed, and/or curved from the planar state.

FIG. 13 is a drawing depicting an exemplary display system 90 in accordance with embodiments of the present invention, in which a circular polarizer 92 according to any of the embodiments is combined with a display device 94. The circular polarizer 92 may be adhered to the display device with an optically clear adhesive layer 96. The thickness of the adhesive layer 96 is minimized to minimize the overall thickness, and thus the stiffness, of the display system 90, i.e., the amount of the optical adhesive preferably is a minimal amount sufficient to perform the adhesive function.

The display device 94 may be a liquid crystal display (LCD) or an organic light-emitting display (OLED). Alternatively, the display device 94 may be a quantum material light-emitting display (QMLED), whereby the quantum material includes quantum dots and/or quantum rods and/or nanocrystals. In a QMLED, direct electrical stimulation of the quantum material is used to produce light. The color of the light emitted from the quantum material may be a function of the chemical structure of the quantum material, the size of the quantum material particles, and/or the shape of the quantum material particles. The use of a circular polarizer according to any of the embodiments in conjunction with an OLED or QMLED type display device is particularly suitable to reduce ambient reflections from these types of display device because the electrodes associated with OLEDs and QMLEDs are typically reflective.

FIG. 14 is a schematic drawing depicting an exemplary display system 90a that is variation of the embodiment of FIG. 13, in which an additional antireflection layer 98 is provided on the viewing side of the optical stack, and in particular may be deposited on the viewing side of the circular polarizer 92. The thickness of the antireflection layer 98 also should be minimized to minimize overall thickness, and thus the stiffness, of the display system 90a for use as a flexible or bendable display system.

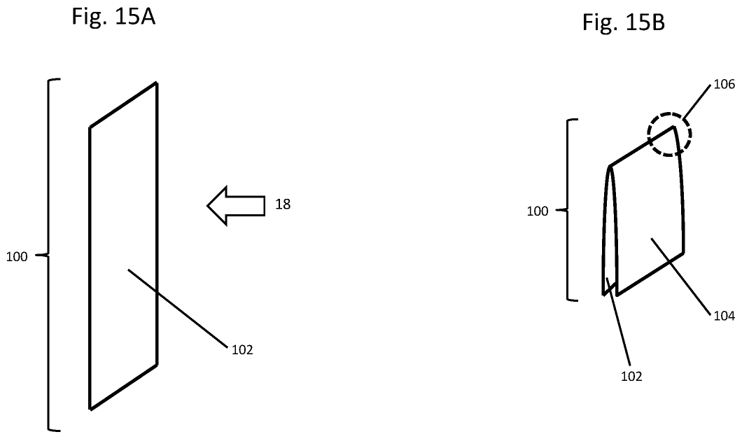

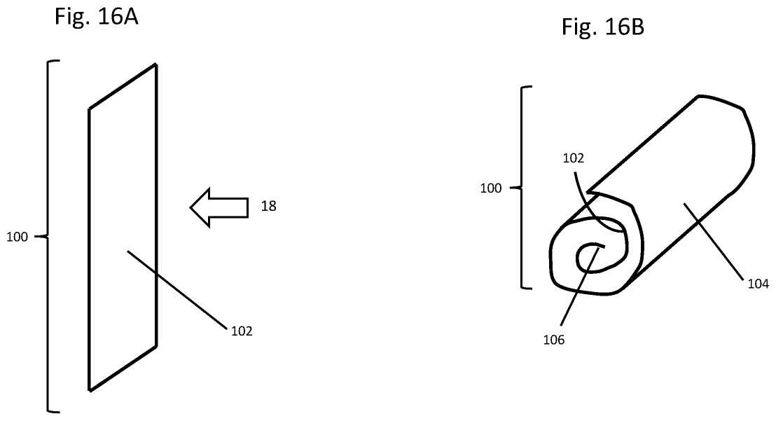

FIGS. 15A and 15B are drawings illustrating how a display system 100, which is configured in accordance with any of the embodiments (including a circular polarizer according to any of the embodiments), may be reconfigured between a first or planar state and a second or non-planar planar state, such as being bent, folded, roller, curved, or otherwise flexed due to the overall thinness of the display system with the thin circular polarizer.

Referring to FIGS. 15A and 15B, the display system 100 has a first side 102 and a second side 104 opposite from the first side (the second side is not visible from the viewpoint of FIG. 15A). In this example, the first side 102 is viewing side relative to the viewing direction 18, and the second side 104 is a non-viewing side. Generally, the display system 100 can be repeatedly transformed between a first or planar state and a second or non-planar state. In a first type of transformation, FIG. 15A illustrates the display in a first state corresponding to a planar state in which the entire display system 100 is essentially straight. The display system 100 may be reconfigured to a second state as illustrated in FIG. 15B, in which the display system in this example essentially is folded. In the second state, the first side 102 constitutes an inner side and the second side 104 constitutes an outer side. The display system 100 also may be reconfigured to intermediate states corresponding to different degrees of folding between the first state of FIG. 15A and the second state of FIG. 15B. In exemplary embodiments, the second state of the display system 100 has at least one spatial region 106 that has a minimum radius of curvature that is less than 10 mm.

Again, in this example the first side 102 is the viewing side, meaning in the folded state images cannot be viewed. Such a configuration, for example, may be suitable to protect the viewing side components for compact storage or transport. The viewing and non-viewing sides may be reversed, however, with the second side 104 being the viewing side. In such configuration, therefore, images are viewable in the folded state which may provide unique viewing modes, such as for example being able to view images from both sides of the display system (and also can provide a more compact arrangement for storage and transport).

FIGS. 16A and 16B are drawings illustrating an alternative method of how a display system 100 may be may be reconfigured between a first or planar state and a second or non-planar planar state. In a second type of transformation, FIG. 16A illustrates the display system 100 in a first state corresponding to a planar state in which the entire display system 100 is essentially straight, which essentially is the same as the first state illustrated in FIG. 15A. The display system 100 may be reconfigured to a second or non-planar state as illustrated in FIG. 16B, in which the display system in this example essentially is rolled. In the second or rolled state, the first side 102 also constitutes an inner side and the second side 104 also constitutes an outer side. Similarly as in folded embodiments, in exemplary rolled embodiments the first side 102 may be the viewing side 18 and second side 104 may be the non-viewing side or the first side 102 may be the non-viewing side and second 104 side may be the viewing side 18. The display system 100 also may be reconfigured to intermediate states corresponding to different degrees of rolling between the first state of FIG. 16A and the second state of FIG. 16B. Similarly as in folded embodiments, in exemplary rolled embodiments, the second (rolled) state of the display system 100 has at least one spatial region 106 that has a minimum radius of curvature that is less than 10 mm. It will also be appreciated that other forms of flexing may be used, such as for example, tri-folding or other multiple folds, asymmetrical or slanted axis folding, rolling from a corner, or others types of bending, flexing, curving, or rolling as may be suitable for any particular usage, storage, transport, or like application.

An aspect of the invention is a flexible circular polarizer that is more suitable for flexible and bendable display systems as compared to conventional configurations. In exemplary embodiments, a flexible circular polarizer includes from a viewing side: a substrate; a liquid crystal (LC) polarizer layer; and a quarter wave plate reactive mesogen (RM) retarder layer. An optical axis of the RM retarder is aligned in a first direction and a transmission axis of the LC polarizer is aligned in a second direction different from the first direction, and an angle between the first and second directions has a value of 45°±15°. At least one of the substrate and the LC polarizer has a surface configuration that imparts an alignment to an adjacent non-viewing side layer. The flexible polarizer may include one or more of the following features, either individually or in combination.

In an exemplary embodiment of the flexible circular polarizer, the LC polarizer layer has a surface configuration that imparts an alignment to the RM retarder in the first direction.

In an exemplary embodiment of the flexible circular polarizer, the flexible circular polarizer further includes an LC polarizer alignment layer deposited between the substrate and the LC polarizer that imparts an alignment to the LC polarizer in the second direction.

In an exemplary embodiment of the flexible circular polarizer, the substrate has a surface configuration that imparts an alignment to the LC polarizer in the second direction.

In an exemplary embodiment of the flexible circular polarizer, the flexible circular polarizer further includes an RM retarder alignment layer deposited between the LC polarizer and the RM retarder that imparts an alignment to the RM retarder in the first direction.

In an exemplary embodiment of the flexible circular polarizer, the LC polarizer has a surface configuration that imparts an alignment to the RM retarder in the first direction, and the substrate has a surface configuration that imparts an alignment to the LC polarizer in the second direction.

In an exemplary embodiment of the flexible circular polarizer, the substrate and the LC polarizer are combined into a single layer, and the combined substrate/LC polarizer has a surface configuration that imparts an alignment to the RM retarder layer in the first direction.

In an exemplary embodiment of the flexible circular polarizer, the substrate is an optically transparent and colorless polymer, and LC polarizer includes either an RM material or a lyotropic LC material.

In an exemplary embodiment of the flexible circular polarizer, the substrate includes at least one of the following materials: polyethylene terephthalate (PET), Poly(methyl methacrylate) (i.e. PMMA), Polyethylene naphthalate (PEN), cyclo olefin polymer (COP), cyclo olefin copolymer (COC), polycarbonate (PC), high temperature polycarbonate (HTPC), polyetherimide (PEI), polyarcylate (PAR), polyphenylene sulfide (PPS), polyethersulfone (PES), polyether ether ketone (PEEK), polyimide (PI) or polyamide imide (PAI).

In an exemplary embodiment of the flexible circular polarizer, the flexible circular polarizer further includes a hard coat layer deposited on a viewing side of the substrate.

In an exemplary embodiment of the flexible circular polarizer, the flexible circular polarizer has a thickness of less than 70 μm.

In an exemplary embodiment of the flexible circular polarizer, the flexible circular polarizer is repeatedly reconfigurable between a planar state and a non-planar state.

In an exemplary embodiment of the flexible circular polarizer, the non-planar state includes a folded state and/or a rolled state.

In an exemplary embodiment of the flexible circular polarizer, in the non-planar state the flexible circular polarizer has a region having a radius of curvature of less than 10 mm.

Another aspect of the invention is a flexible display system that includes from a viewing side the flexible circular polarizer according to any of the embodiments, and a display device that is adhered to the flexible circular polarizer. The display system may include one or more of the following features, either individually or in combination.

In an exemplary embodiment of the display system, the display system further includes an antireflection coating deposited on a viewing side of the flexible circular polarizer.

In an exemplary embodiment of the display system, the display system is repeatedly reconfigurable between a planar state and a non-planar state.

In an exemplary embodiment of the display system, the non-planar state includes a folded state and/or a rolled state.

In an exemplary embodiment of the display system, in the non-planar state the display system has a region having a radius of curvature of less than 10 mm.

Another aspect of the invention is a method of forming a flexible circular polarizer comprising steps of depositing from a viewing side: a substrate; a liquid crystal (LC) polarizer layer; and a quarter wave plate reactive mesogen (RM) retarder layer; wherein an optical axis of the RM retarder is aligned in a first direction and a transmission axis of the LC polarizer is aligned in a second direction different from the first direction, and an angle between the first and second directions has a value of 45°±15°; and prior to depositing an adjacent non-viewing side layer, performing an aligning process on at least one of the substrate and the LC polarizer to form a surface configuration that imparts an alignment to the adjacent non-viewing side layer. The method may include one or more of the following features, either individually or in combination.

In an exemplary embodiment of the method of forming a flexible circular polarizer, an aligning process is performed on the LC polarizer prior to depositing the RM retarder, and the aligning process forms a surface configuration on the LC polarizer that imparts an alignment to the RM retarder in the first direction.

In an exemplary embodiment of the method of forming a flexible circular polarizer, the method further includes depositing an LC polarizer alignment layer between the substrate and the LC polarizer that imparts an alignment to the LC polarizer in the second direction.

In an exemplary embodiment of the method of forming a flexible circular polarizer, an aligning process is performed on the substrate prior to depositing the LC polarizer, and the aligning process forms a surface configuration on the substrate that imparts an alignment to the LC polarizer in the second direction.

In an exemplary embodiment of the method of forming a flexible circular polarizer, the method further includes depositing an RM retarder alignment layer between the LC polarizer and the RM retarder that imparts an alignment to the RM retarder in the first direction.

In an exemplary embodiment of the method of forming a flexible circular polarizer, an aligning process is performed on the substrate prior to depositing the LC polarizer, and the aligning process forms a surface configuration on the substrate that imparts an alignment to the LC polarizer in the second direction; and an aligning process is performed on the LC polarizer prior to depositing the RM retarder, and the aligning process forms a surface configuration on the LC polarizer that imparts an alignment to the RM retarder in the first direction.

In an exemplary embodiment of the method of forming a flexible circular polarizer, the substrate and the LC polarizer are combined into a single layer, an aligning process is performed on the combined substrate/LC polarizer prior to depositing the RM retarder, and the aligning process forms a surface configuration on the combined substrate/LC polarizer that imparts an alignment to the RM retarder in the first direction.

In an exemplary embodiment of the method of forming a flexible circular polarizer, the aligning process is at least one of a rubbing process or an ultraviolet radiation exposure process.

In an exemplary embodiment of the method of forming a flexible circular polarizer, the method further includes depositing a hard coat layer on a viewing side of the substrate.

In an exemplary embodiment of the method of forming a flexible circular polarizer, the flexible circular polarizer has a thickness of less than 70 μm.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

Embodiments of the present invention relate to configurations and manufacturing methods of circular polarizers. The circular polarizers may be adhered to electronic display devices to reduce ambient reflections from said display devices and therefore improve contrast ratio. The electronic display devices may include, but are not limited to, mobile phones, smartphones, personal digital assistants (PDAs), tablet and laptop computers. The electronic display devices may be an emissive type, such as organic light emitting diode (OLED). Principles of the present invention in particular are applicable to display devices that are intended to be bent, folded, rolled, curved, and/or otherwise flexed from a conventional planar configuration for ordinary usage, storage, transport, and the like.

### REFERENCE SIGNS LIST

10—exemplary display system
12—display device
14—conventional circular polarizer
14a—conventional circular polarizer
14b—conventional circular polarizer
16—optical adhesive
18—viewing side
20—linear polarizer
22—retarder layer
24—substrate
26—LC polarizer alignment layer
28—LC polarizer
30—RM retarder alignment layer
32—RM retarder
40—exemplary circular polarizer
40a—exemplary circular polarizer
41—hard coat layer
42—substrate
44—LC polarizer alignment layer
46—LC polarizer
48—RM retarder
50—exemplary circular polarizer
50a—exemplary circular polarizer
51—hard coat layer
52—substrate
54—LC polarizer
56—RM retarder alignment layer
58—RM retarder
60—exemplary circular polarizer
60a—exemplary circular polarizer
61—hard coat layer
62—substrate
64—LC polarizer
66—RM retarder
70—exemplary circular polarizer
70a—exemplary circular polarizer
71—hard coat layer
72—combined substrate/polarizer
74—RM retarder alignment layer
76—RM retarder
80—exemplary circular polarizer
80a—exemplary circular polarizer
81—hard coat layer
82—combined substrate/polarizer
84—RM retarder
90—exemplary display system
90a—exemplary display system
92—circular polarizer
94—display device
96—optically clear adhesive layer
98—antireflection layer
100—display system
102—first side
104—second side
106—spatial region

1. A flexible circular polarizer comprising from a viewing side:
a substrate;
a liquid crystal (LC) polarizer layer; and
a quarter wave plate reactive mesogen (RM) retarder layer;
wherein an optical axis of the RM retarder is aligned in a first direction and a transmission axis of the LC polarizer is aligned in a second direction different from the first direction, and an angle between the first and second directions has a value of 45°±15°; and
wherein at least one of the substrate and the LC polarizer has a surface configuration that imparts an alignment to an adjacent non-viewing side layer.

2. The flexible circular polarizer of claim 1, wherein the LC polarizer layer has a surface configuration that imparts an alignment to the RM retarder in the first direction.

3. The flexible circular polarizer of claim 2, further comprising an LC polarizer alignment layer deposited between the substrate and the LC polarizer that imparts an alignment to the LC polarizer in the second direction.

4. The flexible circular polarizer of claim 1, wherein the substrate has a surface configuration that imparts an alignment to the LC polarizer in the second direction.

5. The flexible circular polarizer of claim 4, further comprising an RM retarder alignment layer deposited between the LC polarizer and the RM retarder that imparts an alignment to the RM retarder in the first direction.

6. The flexible circular polarizer of claim 1, wherein the LC polarizer has a surface configuration that imparts an alignment to the RM retarder in the first direction, and the substrate has a surface configuration that imparts an alignment to the LC polarizer in the second direction.

7. The flexible circular polarizer of claim 1, wherein the substrate and the LC polarizer are combined into a single layer, and the combined substrate/LC polarizer has a surface configuration that imparts an alignment to the RM retarder layer in the first direction.

8. The flexible circular polarizer of claim 1, wherein the substrate is an optically transparent and colorless polymer, and LC polarizer includes either an RM material or a lyotropic LC material.

9. The flexible circular polarizer of claim 1, wherein the substrate includes at least one of the following materials: polyethylene terephthalate (PET), Poly(methyl methacrylate) (i.e. PMMA), Polyethylene naphthalate (PEN), cyclo olefin polymer (COP), cyclo olefin copolymer (COC), polycarbonate (PC), high temperature polycarbonate (HTPC), polyetherimide (PEI), polyarcylate (PAR), polyphenylene sulfide (PPS), polyethersulfone (PES), polyether ether ketone (PEEK), polyimide (PI) or polyamide imide (PAI).

10. The flexible circular polarizer of claim 1, further comprising a hard coat layer deposited on a viewing side of the substrate.

11. The flexible circular polarizer of claim 1, wherein the flexible circular polarizer has a thickness of less than 70 μm.

12. The flexible circular polarizer of claim 1, wherein the flexible circular polarizer is repeatedly reconfigurable between a planar state and a non-planar state.

13. The flexible circular polarizer of claim 12, wherein the non-planar state includes a folded state and/or a rolled state.

14. The flexible circular polarizer of claim 12, wherein in the non-planar state the flexible circular polarizer has a region having a radius of curvature of less than 10 mm.

15. A display system comprising from a viewing side the flexible circular polarizer according to claim 1, and a display device that is adhered to the flexible circular polarizer.

16. The display system of claim 15, further comprising an antireflection coating deposited on a viewing side of the flexible circular polarizer.

17. The display system of claim 15, wherein the display system is repeatedly reconfigurable between a planar state and a non-planar state.

18. The display system of claim 17, wherein the non-planar state includes a folded state and/or a rolled state.

19. The display system of claim 17, wherein in the non-planar state the display system has a region having a radius of curvature of less than 10 mm.

20. A method of forming a flexible circular polarizer comprising steps of depositing from a viewing side:
a substrate;
a liquid crystal (LC) polarizer layer; and
a quarter wave plate reactive mesogen (RM) retarder layer;
wherein an optical axis of the RM retarder is aligned in a first direction and a transmission axis of the LC polarizer is aligned in a second direction different from the first direction, and an angle between the first and second directions has a value of 45°±15°; and
prior to depositing an adjacent non-viewing side layer, performing an aligning process on at least one of the substrate and the LC polarizer to form a surface configuration that imparts an alignment to the adjacent non-viewing side layer.
